(19) United States
(12) Patent Application Publication
(10) Pub. No.: US 2016/0138675 A1
(43) Pub. Date: May 19, 2016

(54) ROPE CLUTCH

(71) Applicant: Gordon CHIH, CHANGHUA HSIEN (TW)

(72) Inventor: Gordon CHIH, CHANGHUA HSIEN (TW)

(21) Appl. No.: 14/939,157

(22) Filed: Nov. 12, 2015

(30) Foreign Application Priority Data
Nov. 14, 2014 (TW) 103220348

(51) Int. Cl. F16G 11/10

(52) U.S. Cl. CPC F16G 11/106

(57) ABSTRACT

A rope clutch includes a base seat, a pair of fixing arms, a pair of first rocking bars, a pair of second rocking bars, a handle and a press mechanism. Each fixing arm has a fixing section at one end. The fixing sections are oppositely connected to two sides of one end of the base seat. The other end of the fixing arm is formed with a support section. One end of each first rocking bar is correspondingly pivotally connected to two sides of the other lengthwise end of the base seat. One end of each second rocking bar is correspondingly pivotally connected to the other end of the first rocking bar. A middle portion of the handle is pivotally connected to the support sections and positioned between the fixing arms. One end of the handle is pivotally connected to the other end of the second rocking bar. The press mechanism is disposed between the first and second rocking bars. The handle serves to drive the first and second rocking bars to provide a clutch effect between the press mechanism and the base seat.

### BACKGROUND OF THE INVENTION

1. Field of the Invention

The present invention relates generally to a rope grasping device, and more particularly to a rope clutch, which permits the rope to be released when the rope is loaded.

2. Description of the Related Art

There are two kinds of conventional rope grasping devices used in a sailing boat. One is a cam cleat for simply grasping a rope. The other is a rope clutch that permits the rope to be released when the rope is still loaded.

Please refer to FIGS. 1 and 2. The conventional rope clutch at least includes an elongated base seat 91, a handle 92, a triangular frame support 93 with an internal space and a stopper block 94. The triangular frame support 93 is composed of a pair of triangular frames. Three rod bodies 931 are respectively used to connect the points of the triangular frames and symmetrically space the triangular frames from each other. One end of the bottom side of the triangular frame support 93 is pivotally connected to one end of the elongated base seat 91. One end of the handle 92 is pivotally connected to a case 95 and positioned above the triangular frame support 93 corresponding to the other end of the bottom side of the triangular frame support 93. One end of the stopper block 94 is pivotally connected to the upper apex of the triangular frame support 93 and positioned inside the triangular frame support 93. A V-shaped spring (not shown) is disposed between the stopper block 94 and one of the triangular frames. The elastic force of the V-shaped spring serves to make the other end of the stopper block 94 swing toward the base seat 91. The handle 92 can be left and right about 180-degree swung to reciprocally angularly displace the triangular frame support 93 so as to form a wide passage (as shown in FIG. 1) between the stopper block 94 and the base seat 91 or a narrow passage (as shown in FIG. 2) between the stopper block 94 and the base seat 91. Accordingly, a rope can be passed through the passage to freely move in the lengthwise direction of the base seat 91 or one-way move in the lengthwise direction of the base seat 91.

The triangular frame support 93 has a fixed configuration. Therefore, when the handle 92 drives the triangular frame support 93 to form the narrow passage between the stopper block 94 and the base seat 91, the handle 92 will apply greater force to the triangular frame support 93 to lead to longer downward displacement of the triangular frame support 93. As a result, the stopper block 94 will deform the rope to a greater extent. This will shorten the lifetime of the rope. Moreover, the swing amplitude of the handle 92 is about 180 degrees so that it is quite inconvenient to use the rope clutch.

### SUMMARY OF THE INVENTION

It is therefore a primary object of the present invention to provide a rope clutch, in which the handle can be gently forced to provide a narrow passage for engaging with a rope and clamping the rope.

It is a further object of the present invention to provide the above rope clutch, which can prolong the lifetime of the rope.

It is still a further object of the present invention to provide the above rope clutch, which includes an insurance mechanism for ensuring the given function of the rope clutch.

To achieve the above and other objects, the rope clutch of the present invention includes a base seat, a pair of fixing arms, a pair of first rocking bars, a pair of second rocking bars, a handle and a press mechanism. Each fixing arm has a fixing section at one end. The fixing sections are oppositely connected to two sides of one end of the base seat. The other end of each fixing arm is respectively formed with a support section. One end of each first rocking bar is correspondingly pivotally connected to two sides of the other lengthwise end of the base seat. One end of each second rocking bar is correspondingly pivotally connected to the other end of each first rocking bar. A middle portion of the handle is pivotally connected to the support sections and positioned between the fixing arms. One end of the handle positioning between the fixing arms is pivotally connected to the other end of each second rocking bar. The press mechanism is disposed between the first and second rocking bars. The handle serves to drive the first and second rocking bars to provide a clutch effect between the press mechanism and the base seat.

The present invention can be best understood through the following description and accompanying drawings, wherein:

### BRIEF DESCRIPTION OF THE DRAWINGS

FIG. 1 is a front view of a conventional rope clutch, showing that a rope is permitted to freely move;

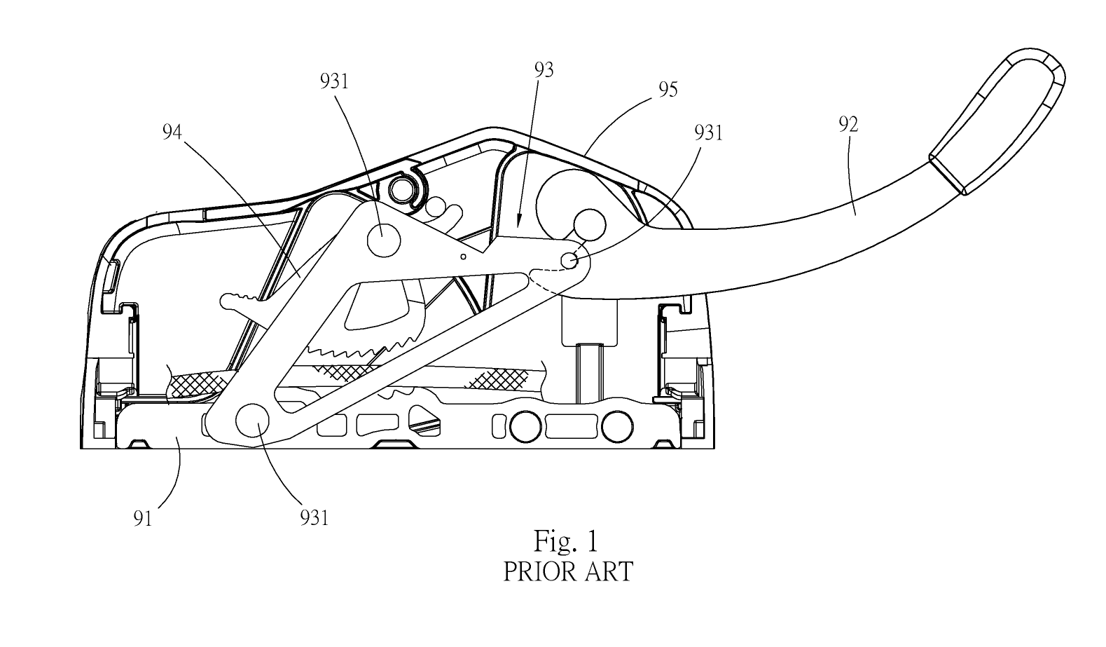

FIG. 2 is a front view of the conventional rope clutch, showing that the rope is only permitted to one-way move;

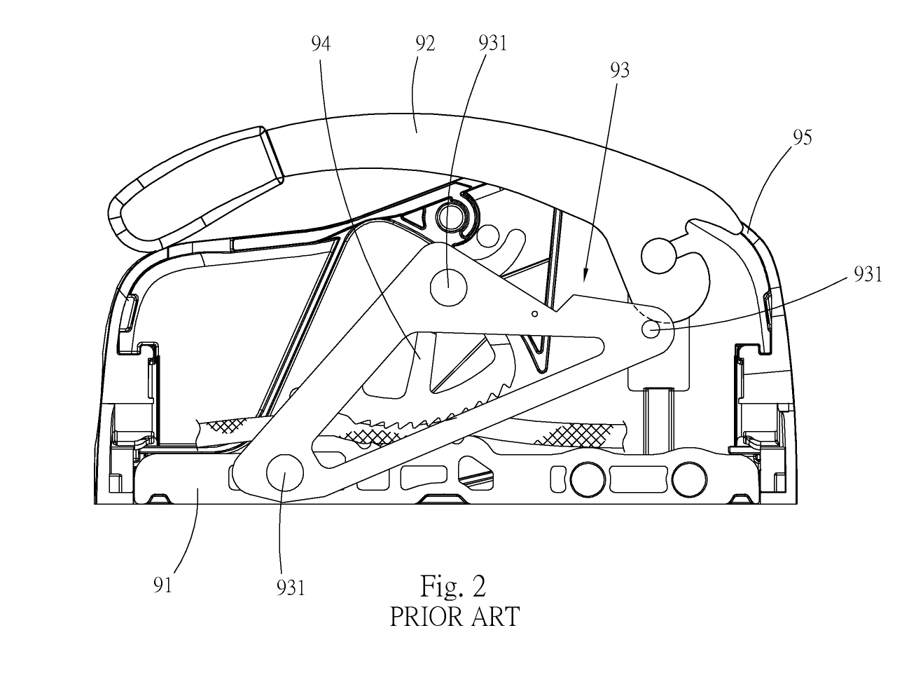

FIG. 3 is a perspective assembled view of a first embodiment of the present invention;

FIG. 4 is a perspective exploded view of the first embodiment of the present invention;

FIG. 5 is a perspective assembled view of a second embodiment of the present invention;

FIG. 6 is a perspective exploded view of the second embodiment of the present invention;

FIG. 7 is a front sectional view taken along a lengthwise direction of the base seat according to FIG. 3, showing that the handle is positioned in the first position;

FIG. 8 is a sectional view according to FIG. 7, showing that a rope is passed through the rope clutch of the present invention;

FIG. 9 is a front sectional view taken along the lengthwise direction of the base seat according to FIG. 3, showing that the handle is positioned in the second position;

FIG. 10 is a sectional view according to FIG. 9, showing that the rope is passed through the rope clutch of the present invention;

FIG. 11 is a perspective view according to FIG. 3, showing that the rope clutch is enclosed in a case;

FIG. 12 is a perspective exploded view according to FIG. 11, showing that the case is composed of two half-cases; and

FIG. 13 is a front view according to FIG. 11, in which one of the half-cases is removed.

### DETAILED DESCRIPTION OF THE PREFERRED EMBODIMENTS

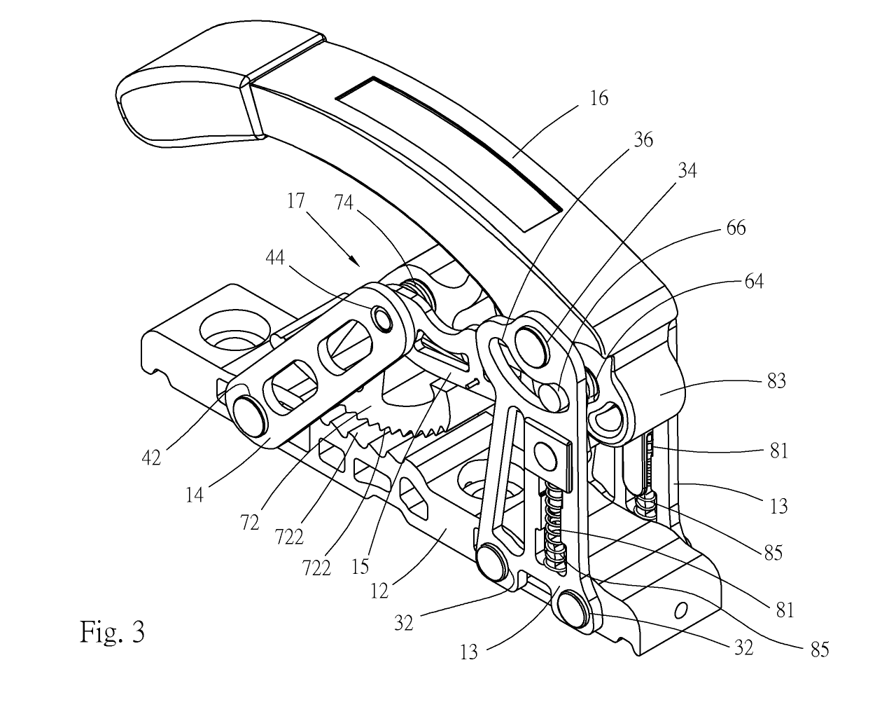

Please refer to FIGS. 3 to 10. The rope clutch of the present invention at least includes a base seat 12, a pair of fixing arms 13, a pair of first rocking bars 14, a pair of second rocking bars 15, a handle 16 and a press mechanism 17.

The base seat 12 is an elongated body with a certain thickness.

Each fixing arm 13 has a fixing section 32 such as a perforation at one end. A lengthwise end of the base seat 12 is formed with a through hole between two sides. A rod body is passed through the fixing sections 32 and the through hole of the base seat 12 to connect the fixing arm 13 with the base seat 12 by means of riveting or screwing. The two fixing arms 13 are oppositely connected with the seat body 12 and spaced from each other. The other end of each fixing arm 13 is formed with a support section 34 such as a perforation. The support sections 34 of the fixing arms 13 are opposite to each other and up and down spaced from the base seat 12 by a certain distance.

One end of each first rocking bar 14 is formed with a first connection section 42 such as a perforation. A rod body is passed through the first connection sections 42 of the first rocking bars corresponding to the direction of the fixing arms 13 to pivotally connect to a through hole of the other lengthwise end of the base seat 12 between two sides of the base seat 12 by means of riveting. The other end of each first rocking bar 14 is formed with a second connection section 44 such as a perforation.

One end of each second rocking bar 15 is formed with a third connection section 52 such as a perforation corresponding to the second connection section 44. A rod body is passed through the third connection section 52 and the second connection section 44 to pivotally connect the third connection section 52 to the second connection section 44 by means of riveting. The other end of each second rocking bar 15 is formed with a fourth connection section 54 such as a perforation.

The handle 16 is positioned between the pair of fixing arms 13 and spaced from the base seat 12 by a certain distance. A middle portion of the handle 16 is formed with a fifth connection section 62 such as a perforation. A rod body fitted in a circular sleeve is passed through the fifth connection section 62 to pivotally connect to the support sections 34 of the fixing arms 13 by means of riveting. The handle 16 is further formed with a sixth connection section 64 in adjacency to the fifth connection section 62. The sixth connection section 64 is positioned between the fifth connection section 62 and the base seat 12. The sixth connection section 64 is such as a perforation. A rod member is passed through the sixth connection section 64 to pivotally connect to the fourth connection sections 54 by means of riveting. The handle 16 is movable between a first position and a second position to drive the first and second rocking bars 14, 15.

The press mechanism 17 at least includes a press body 72 and a first elastic body 74. A seventh connection section 721 such as a perforation is disposed at one end of the press body 72. The rod body passed through the second and third connection sections 44, 52 is also passed through the seventh connection section 721 to pivotally connect the press body 72 with the first and second rocking bars 14, 15 and position the press body 72 between the first rocking bars 14 or the second rocking bars 15.

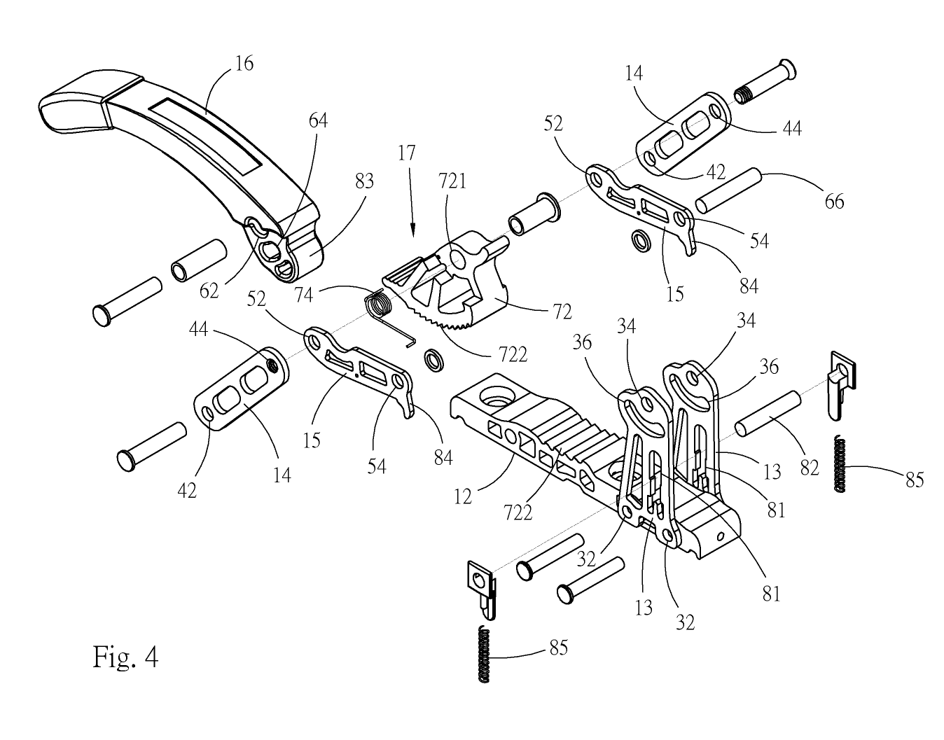

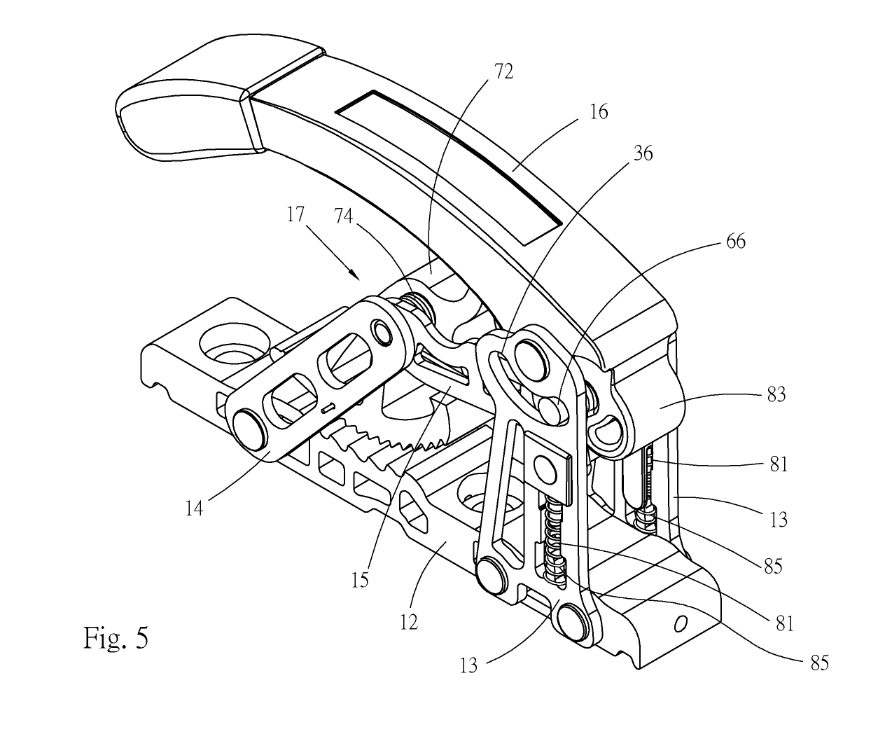

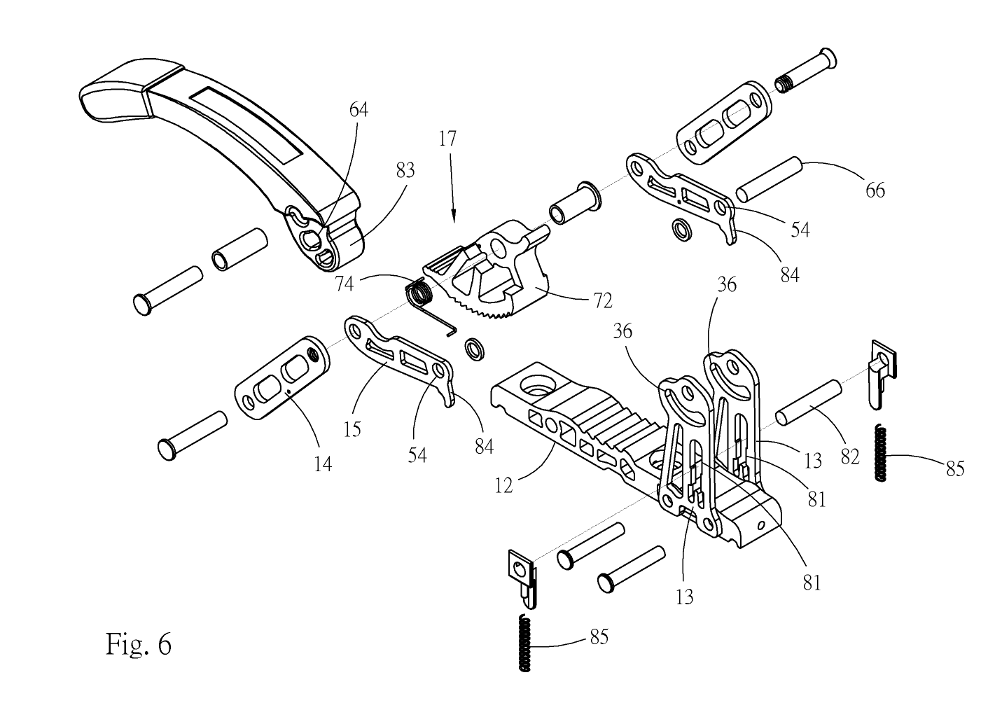

The first elastic body 74 is such as a V-shaped spring. One end of the first elastic body 74 is fixedly engaged and connected with the press body 72. The other end of the first elastic body 74 is fixedly connected to one of the first rocking bars 14 (as shown in FIGS. 5 and 6) or one of the second rocking bars 15 (as shown in FIGS. 3 and 4). The first elastic body 74 serves to apply an elastic force to the press body 72 so as to make the other end of the press body 72 swing toward the fixing arms 13. In other words, the elastic force of the first elastic body 74 serves to make the other end of the press body 72 get closer to the base seat 12.

At least one ratchet 722 is disposed on outer face of the other end of the press body 72 and/or one face of the base seat 12 corresponding to the outer face of the other end of the press body 72. As shown in the drawings, the ratchet 722 outward protrudes in a direction away from the fixing arms 13. When an article is clamped between the press body 72 and the base seat 12, the ratchet 722 serves to more effectively engage with the article to restrict the article from moving toward the fixing arms 13. Reversely, it is easy for the article to move in a direction away from the fixing arms 13.

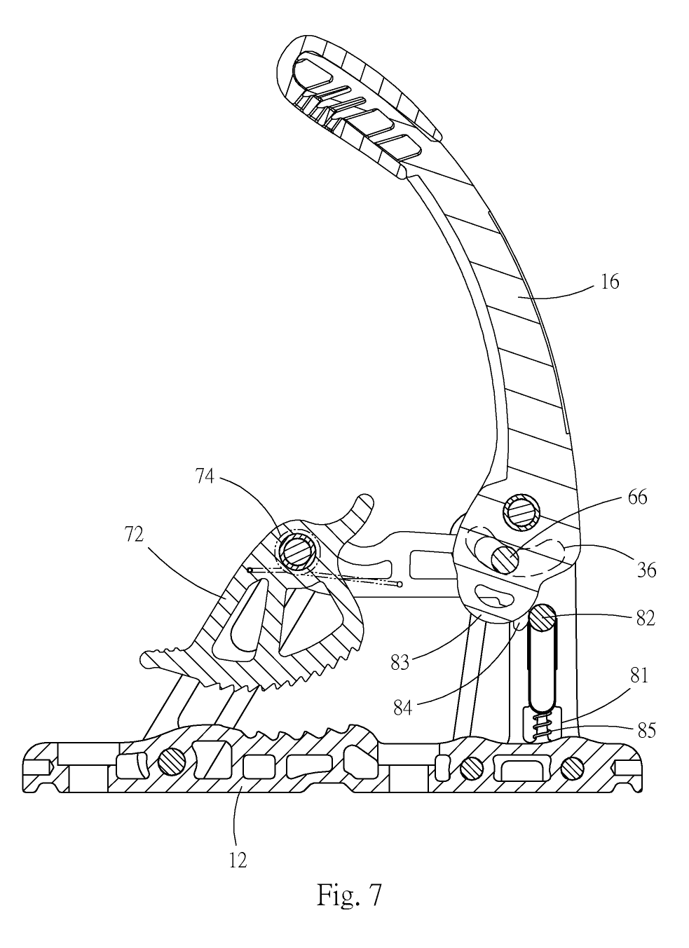

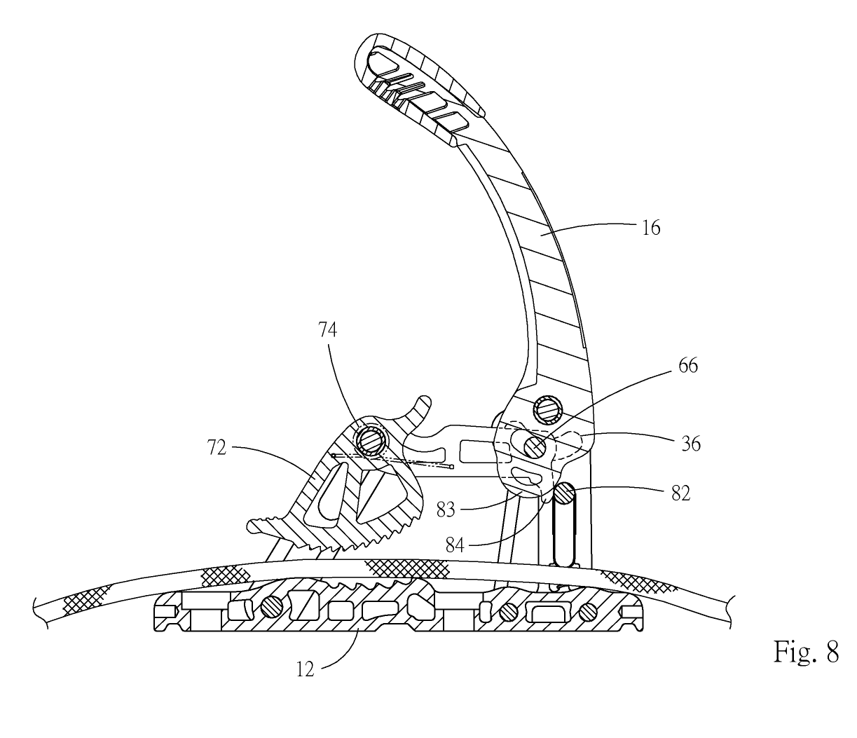

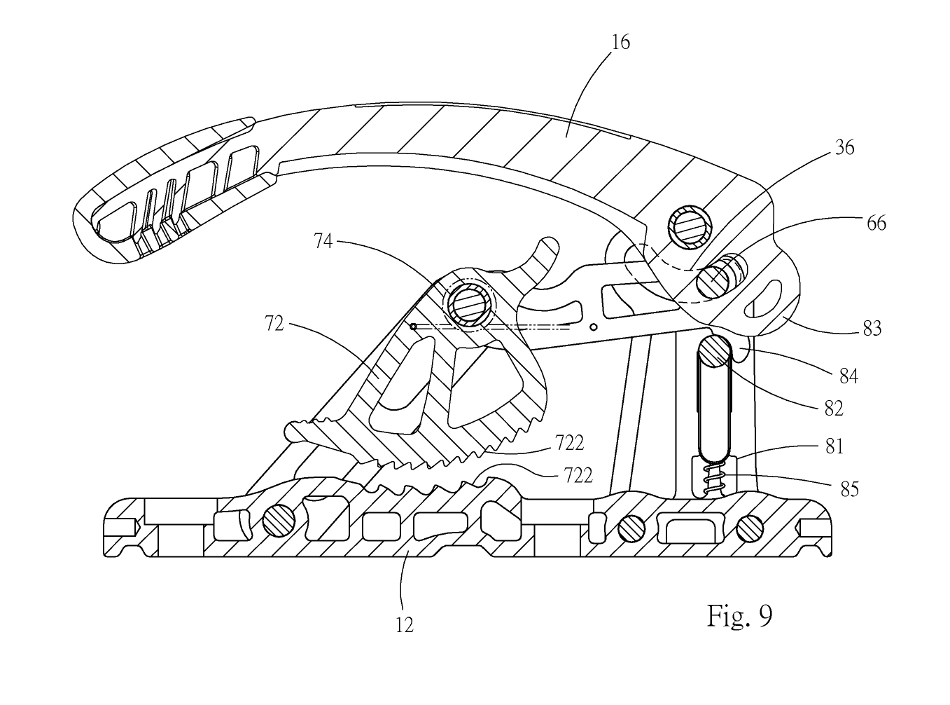

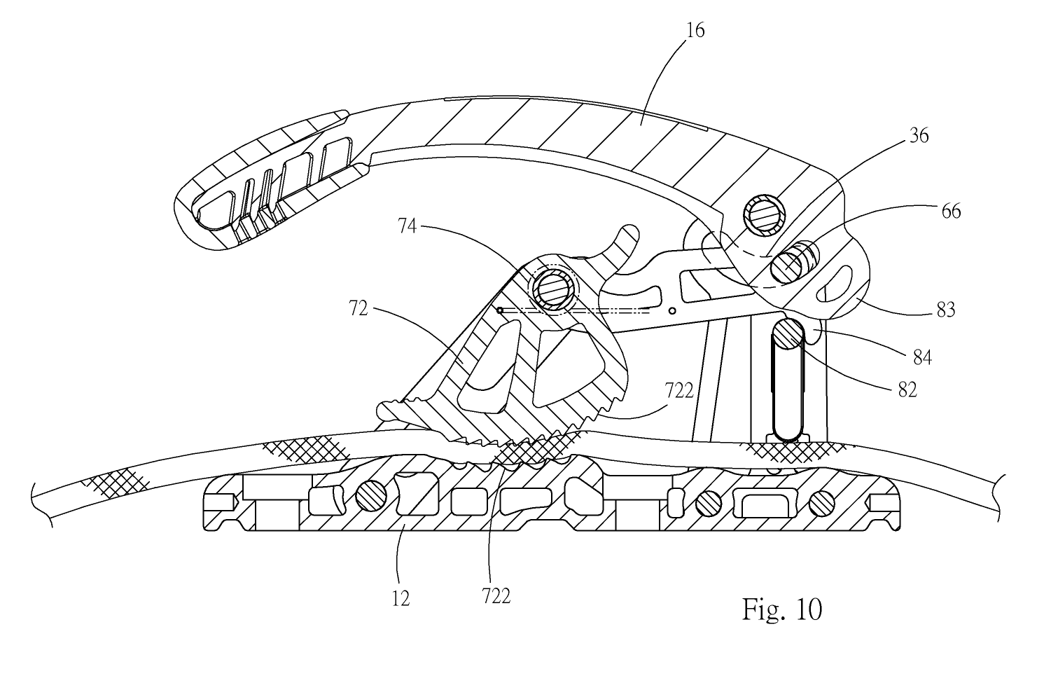

When the handle 16 is operated and moved to the first position to drive the first and second rocking bars 14, 15 and the press body 72 (as shown in FIGS. 7 and 8), a wide passage is formed between the press body 72 and the base seat 12 for a rope to pass through in a lengthwise direction of the base seat 12. Under such circumstance, the rope is permitted to freely move in the lengthwise direction of the base seat 12. When the handle 16 is operated and moved to the second position (as shown in FIGS. 9 and 10), the passage is narrowed, whereby the elastic force of the first elastic body 74 and the ratchet 722 only permit the rope to one-way move in the lengthwise direction of the base seat 12.

In the present invention, the first rocking bars 14 and the second rocking bars 15 are pivotally connected. Therefore, when the handle 16 is operated and moved from the first position to the second position, the displacement of the press body 72 in the lengthwise direction of the base seat 12 is larger than the displacement of the press body 72 in vertical direction. Accordingly, the handle 16 can be gently forced to provide a narrow passage. In other words, the handle 16 can be gently operated to engage with the rope and clamp the rope.

Please now refer to FIGS. 3 to 10. In the rope clutch of the present invention, a first slide guide section 36 such as an arched slot is formed on each fixing arm 13 in adjacency to the support section 34. A second slide guide section 66 is disposed on the handle 16 and slidable within the first slide guide section 36. The second slide guide section 66 can be two outer ends of the rod body originally passing through the fourth and sixth connection sections 54, 64 so as to save parts and room. The arched first slide guide section 36 enables a user to more securely operate and locate the handle 16, whereby the present invention can provide better effect in use. Please further refer to FIGS. 3 to 10. The rope clutch of the present invention further includes an insurance mechanism. The insurance mechanism at least includes an insurance slide section 81, an insurance rod 82, a push section 83, an insurance hook 84 and a second elastic body 85.

The insurance slide section 81 is formed on each fixing arm 13 between the support section 34 and the fixing section 32.

Two ends of the insurance rod 82 are respectively slidably disposed in the insurance slide sections 81 and positioned between the handle 16 and the base seat 13.

The push section 83 outward extends from the sixth connection section 64 of the handle 16.

The insurance hook 84 bends and extends from the fourth connection section 54 of each second rocking bar 15 toward the base seat 13.

The second elastic bodies 85 are respectively disposed between two ends of the insurance rod 82 and the insurance slide sections 81. The second elastic bodies 85 are such as coiled springs. The second elastic bodies 85 serve to push the insurance rod 82 toward the handle 16 and locate the insurance rod 82 in an upper position. When the handle 16 is operated to swing between the first and second positions, the push section 83 pushes the insurance rod 82 toward the base seat 12. Simultaneously, the insurance hooks 84 are driven to together pass over the insurance rod 82. Thereafter, the insurance rod 82 is restored to the upper position so as to prevent the pair of second rocking bars 15 from restoring to their original positions. In other words, with the handle 16 not operated, the insurance rod 82 can ensure the current function of the present invention.

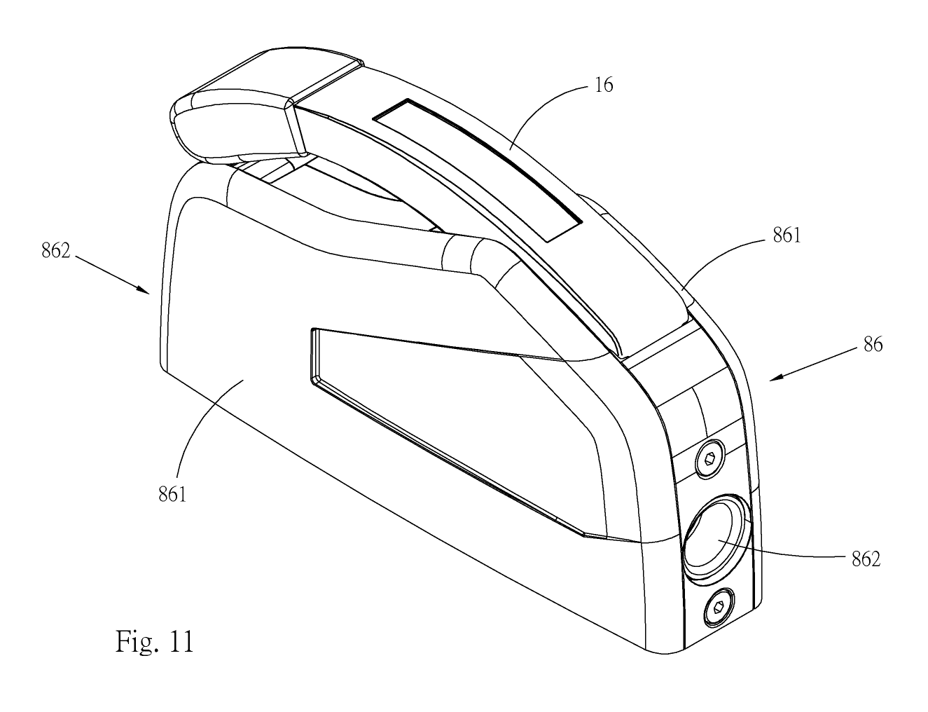

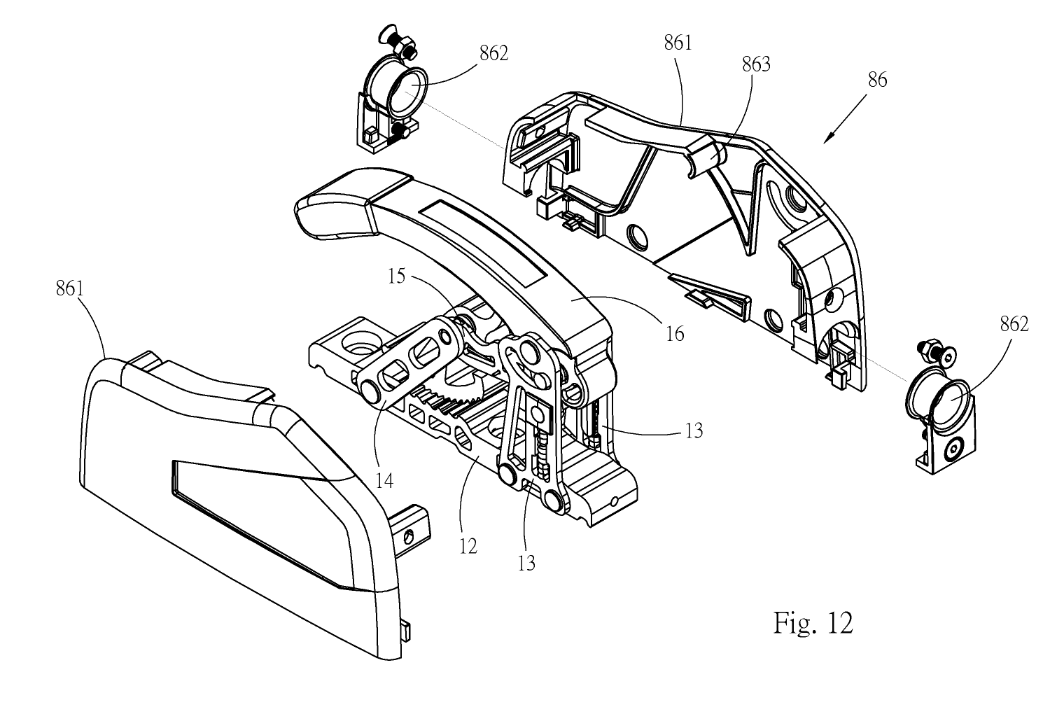

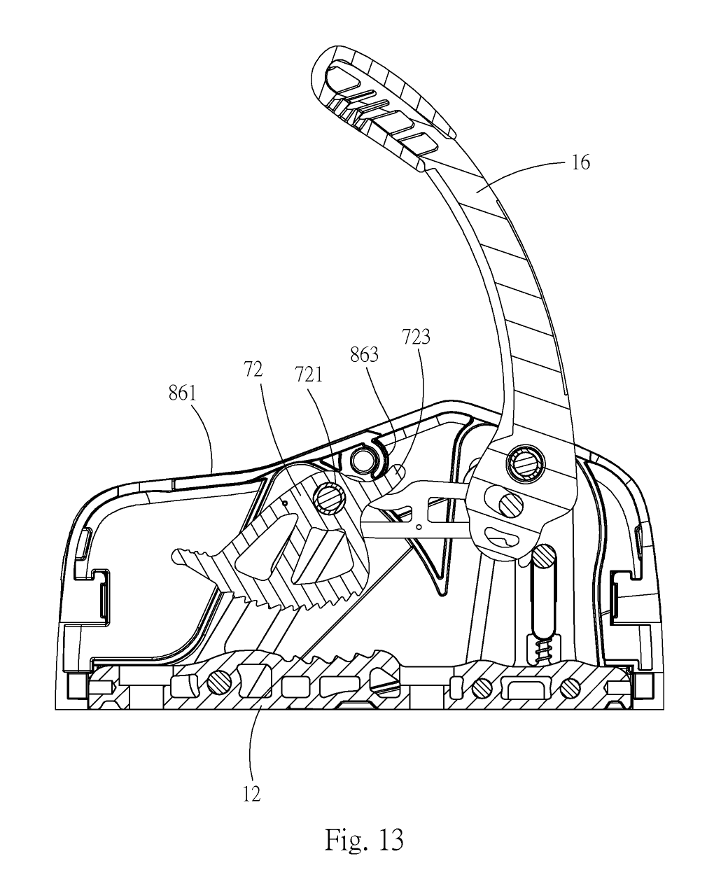

Please refer to FIGS. 11, 12 and 13. The rope clutch of the present invention further includes a case 86 for enclosing the fixing arms 13, the first rocking bars 14, the second rocking bars 15, a part of the base seat 12 and a part of the handle 16. The case 86 is composed of two half-cases 861 symmetrically spaced from each other. Each of two ends of the case 86 is formed with an opening 862 for the rope to go into and out of the case 86.

A protrusion section 723 outward extends from the seventh connection section 721 of the press body 72. A stopper section 863 is formed on inner side of one of the half-cases 861 in adjacency to the protrusion section 723. When the handle 16 is moved from the second position to the first position, the stopper section 863 serves to stop the protrusion section 723 and swing the press body 72 so as to enlarge the gap between the press body 72 and the base seat 12 for the rope to more smoothly move.

The present invention has the following advantages:
1. The first rocking bars 14 and the second rocking bars 15 are pivotally connected. Therefore, when the handle 16 is operated and moved from the first position to the second position, the displacement of the press body 72 in the lengthwise direction of the base seat 12 is larger than the displacement of the press body 72 in vertical direction. Accordingly, the handle 16 can be gently forced to provide a narrow passage for engaging with the rope and clamping the rope.
2. By means of the insurance mechanism, the given function of the present invention can be ensured.
3. When the present invention is in a rope-releasing state, the handle 16 is upright. Therefore, when it is desired to press and clamp the rope, the handle 16 can be easily operated and the pressing travel and time are shortened.
4. When the present invention is in the rope-releasing state, the design of the protrusion section 723 of the press body 72 and the stopper section 863 serves to enlarge the gap between the press body 72 and the base seat 12, whereby the rope can more smoothly move.

The above embodiments are only used to illustrate the present invention, not intended to limit the scope thereof. Many modifications of the above embodiments can be made without departing from the spirit of the present invention.

What is claimed is:

1. A rope clutch comprising:
a base seat;
a pair of fixing arms, each fixing arm having a fixing section at one end, the fixing sections being connected to two sides of a lengthwise end of the base seat, the two fixing arms being oppositely connected with the seat body and spaced from each other, the other end of the fixing arm being formed with a support section, the support sections of the fixing arms being up and down spaced from the base seat by a certain distance;
a pair of first rocking bars, one end of each first rocking bar being formed with a first connection section directed to the fixing arm, the first connection sections of the first rocking bars corresponding to the direction of the fixing arms being pivotally connected to two sides of the other lengthwise end of the base seat, the other end of each first rocking bar being formed with a second connection section;
a pair of second rocking bars, one end of each second rocking bar being formed with a third connection section corresponding to the second connection section, the third connection section being pivotally connected to the second connection section, the other end of each second rocking bar being formed with a fourth connection section;
a handle positioned between the pair of fixing arms and spaced from the base seat by a certain distance, a middle portion of the handle being formed with a fifth connection section, the fifth connection section being pivotally connected to the support sections of the fixing arms, the handle being further formed with a sixth connection section in adjacency to the fifth connection section, the sixth connection section being positioned between the fifth connection section and the base seat, the sixth connection section being pivotally connected to the fourth connection sections, the handle being movable between a first position and a second position to drive the first and second rocking bars; and
a press mechanism at least including a press body and a first elastic body, a seventh connection section being formed at one end of the press body, the seventh connection section being pivotally connected to a position between being selected from a group consisting of the first rocking bars and the second rocking bars, one end of the first elastic body being disposed on the press body, the other end of the first elastic body being disposed on being selected from a group consisting of one of the first rocking bars and one of the second rocking bars, the first elastic body serving to make the other end of the press body swing toward the fixing arms, at least one ratchet being disposed on being selected from a group consisting of outer face of the other end of the press body, one face of the base seat corresponding to the outer face of the other end of the press body and the foregoing both, when the handle is positioned in the first position, a wide passage being formed between the press body and the base seat for a rope to pass through in a lengthwise direction of the base seat, whereby the rope is permitted to freely move in the lengthwise direction of the base seat, when the handle is positioned in the second position, the passage being narrowed and the elastic force of the first elastic body and the ratchet only permit the rope to one-way move in the lengthwise direction of the base seat.

2. The rope clutch as claimed in claim 1, wherein a first slide guide section is further formed on each fixing arm in adjacency to the support section, a second slide guide section being disposed on the handle and slidable within the first slide guide section.

3. The rope clutch as claimed in claim 1, further comprising an insurance mechanism, the insurance mechanism at least including an insurance slide section, an insurance rod, a push section, an insurance hook and a second elastic body, the insurance slide section being formed on each fixing arm between the support section and the fixing section, two ends of the insurance rod being respectively slidably disposed in the insurance slide sections and positioned between the handle and the base seat, the push section outward extending from the sixth connection section of the handle, the insurance hook outward bending and extending from the fourth connection section of each second rocking bar, the second elastic bodies being respectively disposed between two ends of the insurance rod and the insurance slide sections, the second elastic bodies serving to push the insurance rod toward the handle and locate the insurance rod in an upper position, when the handle swings between the first and second positions, the push section pushing the insurance rod toward the base seat and simultaneously driving the insurance hooks to together pass over the insurance rod, thereafter, the insurance rod being restored to the upper position so as to prevent the pair of second rocking bars from restoring to their original positions.

4. The rope clutch as claimed in claim 2, further comprising an insurance mechanism, the insurance mechanism at least including an insurance slide section, an insurance rod, a push section, an insurance hook and a second elastic body, the insurance slide section being formed on each fixing arm between the first slide guide section and the fixing section, two ends of the insurance rod being respectively slidably disposed in the insurance slide sections and positioned between the handle and the base seat, the push section outward extending from the sixth connection section of the handle, the insurance hook outward bending and extending from the fourth connection section of each second rocking bar, the second elastic bodies being respectively disposed between two ends of the insurance rod and the insurance slide sections, the second elastic bodies serving to push the insurance rod toward the handle and locate the insurance rod in an upper position, when the handle swings between the first and second positions, the push section pushing the insurance rod toward the base seat and simultaneously driving the insurance hooks to together pass over the insurance rod, thereafter, the insurance rod being restored to the upper position so as to prevent the pair of second rocking bars from unexpectedly restoring to their original positions.

5. The rope clutch as claimed in claim 3, wherein the insurance mechanism further includes a case for enclosing the fixing arms, the first rocking bars, the second rocking bars, a part of the base seat and a part of the handle, the case being composed of two half-cases symmetrically spaced from each other, each of two ends of the case being formed with an opening in the lengthwise direction of the base seat for the rope to go into and out of the case, a protrusion section outward extending from the seventh connection section of the press body, a stopper section being formed on inner side of one of the half-cases in adjacency to the protrusion section, when the handle is moved from the second position to the first position, the stopper section serving to stop the protrusion section and swing the press body so as to enlarge the gap between the press body and the base seat.

6. The rope clutch as claimed in claim 4, wherein the insurance mechanism further includes a case for enclosing the fixing arms, the first rocking bars, the second rocking bars, a part of the base seat and a part of the handle, the case being composed of two half-cases symmetrically spaced from each other, each of two ends of the case being formed with an opening in the lengthwise direction of the base seat for the rope to go into and out of the case, a protrusion section outward extending from the seventh connection section of the press body, a stopper section being formed on inner side of one of the half-cases in adjacency to the protrusion section, when the handle is moved from the second position to the first position, the stopper section serving to stop the protrusion section and swing the press body so as to enlarge the gap between the press body and the base seat.

7. The rope clutch as claimed in claim 1, wherein the ratchet is disposed on the outer face of the press body and the outer face of the press body is arched.

8. The rope clutch as claimed in claim 3, wherein the ratchet is disposed on the outer face of the press body and the outer face of the press body is arched.

9. The rope clutch as claimed in claim 1, wherein the first elastic body is a V-shaped spring.

10. The rope clutch as claimed in claim 3, wherein the first elastic body is a V-shaped spring.

11. The rope clutch as claimed in claim 1, wherein the second elastic body is a coiled spring.

12. The rope clutch as claimed in claim 3, wherein the second elastic body is a coiled spring.

13. The rope clutch as claimed in claim 1, wherein the push section has an arched outer face.

14. The rope clutch as claimed in claim 3, wherein the push section has an arched outer face.

15. The rope clutch as claimed in claim 2, wherein the first slide guide section is arched.

16. The rope clutch as claimed in claim 4, wherein the first slide guide section is arched.

17. The rope clutch as claimed in claim 6, wherein the first slide guide section is arched.

18. The rope clutch as claimed in claim 2, wherein the second slide guide section is a rod body passing through the fourth and sixth connection sections.

19. The rope clutch as claimed in claim 4, wherein the second slide guide section is a rod body passing through the fourth and sixth connection sections.

20. The rope clutch as claimed in claim 6, wherein the second slide guide section is a rod body passing through the fourth and sixth connection sections.
